(19) United States
(12) Patent Application Publication
(10) Pub. No.: US 2015/0100795 A1
(43) Pub. Date: Apr. 9, 2015

(54) Secure Storage Devices, Authentication Devices, and Methods Thereof

(71) Applicant: Microsemi Corporation, Aliso Viejo, CA (US)

(72) Inventors: Daniel P. Fogelson, Chandler, AZ (US); Sabrina S. Pina, Phoenix, AZ (US); Rudolph J. Sterbenz, Chandler, AZ (US); Kenneth R. Paxman, Chandler, AZ (US); Robert V. Lazaravich, Chandler, AZ (US)

(21) Appl. No.: 14/508,655

(22) Filed: Oct. 7, 2014

Related U.S. Application Data
(60) Provisional application No. 61/887,609, filed on Oct. 7, 2013.

(51) Int. Cl. G06F 21/82

(52) U.S. Cl. CPC G06F 21/82
USPC 713/193

(57) ABSTRACT

Various devices may benefit from enhanced security. For example, secure storage devices and authentication devices may benefit from security that permits isolation of the devices from the operating system and data ports of a host computer. An apparatus can include a first interface configured to connect to a non-volatile storage device. The apparatus can also include circuitry configured to supply an encryption key over the first interface to decrypt data on the non-volatile storage device. The first interface is configured to connect directly to the non-volatile storage device.

### CROSS-REFERENCE TO RELATED APPLICATION

The present application is related to and claims the benefit and priority of U.S. Provisional Patent Application No. 61/887,609, filed Oct. 7, 2013, the entirety of which is hereby incorporated herein by reference.

### BACKGROUND

1. Field

Various devices may benefit from enhanced security. For example, secure storage devices and authentication devices may benefit from security that permits isolation of the devices from the operating system software and shared data ports of a host computer.

2. Description of the Related Art

Data in computers is generally at risk of unauthorized access. Data in laptops may be at a particularly high risk, because people travel with them and because the drives are often not encrypted. Travelers often leave their devices in hotel rooms, taxis, buses, airplanes, and so forth. Laptops left unattended can have their drives cloned, and then the hacker can take as long as needed to determine the password.

Universal serial bus (USB) key fobs have been in use for many years to secure software packages. Some manufacturers use them for storing encryption keys. Conventional key fobs plug directly into the computer. Thus, the operating system of the computer is involved in each of the key-fill, key exchange and authentication processes. Thus, the operating system has access to much of the security process. Moreover, existing storages devices do not provide a simple manual method to clear or sanitize the device or to clear encryption keys externally.

### SUMMARY

According to certain embodiments, an apparatus can include a first interface configured to connect to a non-volatile storage device. The apparatus can also include circuitry configured to supply an encryption key over the first interface to decrypt data on the non-volatile storage device. The first interface is configured to connect directly to the non-volatile storage device.

In certain embodiments, a system can include a non-volatile storage device comprising a first interface to a host computer and a second interface away from the host computer. The system can also include a crypto key device that includes a third interface configured to connect to the second interface of the non-volatile storage device and circuitry configured to supply an encryption key over the third interface to decrypt data on the non-volatile storage device. The third interface is configured to connect directly to the second interface.

### BRIEF DESCRIPTION OF THE DRAWINGS

For proper understanding of the invention, reference should be made to the accompanying drawings, wherein:

FIG. 1 illustrates an apparatus according to certain embodiments.

FIG. 2 illustrates a system according to certain embodiments.

FIG. 3 illustrates a method according to certain embodiments.

FIG. 4 illustrates a particular system according to certain embodiments.

FIG. 5 illustrates a particular method according to certain embodiments.

FIG. 6 illustrates a further method according to certain embodiments.

FIG. 7 illustrates an additional method according to certain embodiments.

### DETAILED DESCRIPTION

Certain embodiments of the present invention use a key fob for such functions as encryption key storage, anti-counterfeiting, and advanced authentication. The key fob, according to certain embodiments, can include a second interface that can be implemented as a standard USB interface to allow connection to other types of USB devices for the purpose of adding additional authentication or security. The key fob of certain embodiments also can have the capability of using the fob's primary interface to communicate directly to standard, defense-grade, serial key-fill devices.

Certain embodiments include a small port, such as a slot or hole, that allows a peg-like tool to initiate an encryption key purge or full disk erase. Certain embodiments can also have the ability to support a secure storage device with multifactor authentication, placed into the DVD/CD-ROM slot of a computing device, the secure storage device having separate authentication ports. The peg-like tool can include a strong magnet configured to destroy or permanently disable the device. For example, the erase stick could be completely or mostly a magnet. When the erase stick is inserted into the drive the magnetic field from the stick can be very strong and very close to the magnetic random access memory (RAM) in the drive. This large magnetic field can permanently destroy the magnetic RAM, which can then permanently disable the drive. The destruction of the RAM can also makes any key data saved in the magnetic RAM forensically unrecoverable.

Certain embodiments bypass the operating system and couple a secure storage device, such as a secure solid state drive, with a key fob. In this discussion, a drive is an example of one type of non-volatile storage device. Other types of non-volatile storage devices are also permitted. The secure storage device can also be coupled with one or more of a key-fill device, a keyboard, a biometric device, a data storing device, or a location detecting device.

More particularly, certain embodiments can include a secure storage device, such as a solid state drive, with built-in encryption, loadable encryption keys, passwords, or other authentication data that can fully isolate the authentication, key filling/loading, and password entering operations from the host computer and from all data ports on the host computer. The full isolation from the host computer can ensure that a hacked, corrupted, or malfunctioning host computer does not have the possibility or ability to access the encryption keys, password, or other authentication data located in the secure storage device or attached authentication devices.

One configuration of certain embodiments may allow the secure storage device to replace the existing DVD/CD-ROM device in a laptop or host computer. The bezel of the secure storage device can include a connector designed to accept a multi-purpose key fob containing or otherwise providing encryption key data and authentication data. The key fob can be designed so that securing the key fob can secure the data in the laptop even if the laptop is lost or stolen. For example, the system can require that both the key fob and the secure storage device are present for the laptop to access data on the secure storage device.

The encrypting secure storage device, key fob, key-filler device, and keyboard, can form a very flexible multi-factor authenticating data security system that operates independently of the operating system and is capable of operating in several different modes to deliver the different levels of security as needed for an application. The system can provide multi-factor authentication by requiring something known, such as a password entered using a keyboard, something possessed, such as the key fob, and something authorized, such as the specific laptop or host computer that holds the secure storage device.

Various features can be included in certain embodiments. For example, in certain embodiments a digital versatile disk/compact disk read only memory (DVD/CD-ROM) device of a standard computer, netbook, or laptop can be replaced with a secure storage device with the capability of performing encryption and multi-factor authentication. After authentication succeeds, the host computer may be permitted to boot the operating system.

Additionally, certain embodiments may provide a method that separates authentication and encryption key filling for a storage device attached to a host computer, such as a laptop. This method may not require major changes to the host system.

Furthermore, certain embodiments provide a method to provide authentication by entering the password or other authentication data by attaching a standard USB keyboard to second interface on a key fob.

Moreover, certain embodiments provide a method to simplify the secure loading of the same encryption key into multiple or a fixed number of host computer systems by pairing the key fob first with an initial host system, then sequentially with each computer system that will share the encryption key. As the key fob pairs with each additional system, it can decrement an internal counter, or can use another method to limit how many systems share the same key.

Also, certain embodiments can provide a method to interface a standard USB keyboard to a serial key-fill port. This method can use a key fob that plugs directly into a dedicated, single purpose, data port on the secure storage device. The other end of the key fob can have a second interface implemented, for example, as a USB connector to accept a standard USB keyboard. Data entered using the keyboard can be transformed and transferred into an appropriate format and protocol required by the dedicated, single purpose, data port on the secure storage device. LEDs or a small display on the key fob can provide feedback and/or status of passwords, keys, or other data entered.

In certain further embodiments, a recessed slot or hole in the bezel of the secure storage device can allow the entire contents of the secure media to be erased or the encryption key purged quickly, with a simple, quick operation. The erase operation can be initiated by inserting a small peg-like tool into the hole in the bezel of the secure storage device. When the secure storage device detects insertion of the peg-like device, the erase operation can begin. The secure storage device can rely on its own power source to perform this operation, or may be powered via the host computer. The peg-like tool can have a loop at the end that allows it to attach to a key chain, making it readily available whenever an emergency erase operation is necessary.

Certain additional embodiments provide a method to simplify and ease removal of an authenticated primary secure storage boot device from a computer system, netbook, or laptop. Removal of the key fob or the entire secure storage device during normal operation can cause the secure storage device to shut down to keep the data secure.

Also, certain embodiments may provide an ability to support a key-fill operation using a standard, defense-grade serial key-fill device. Furthermore, certain embodiments may provide the ability to obfuscate the presence of a multifactor secure primary boot device as a common DVD/CD-ROM.

The key fob, according to certain embodiments, can include an authentication feature. The key fob authentication can provide a way for the secure storage device to know that the key fob is authentic and not a counterfeit key fob. The authentication can take the form of a shared secret, a previously performed pairing operation, a split key, a physical unclonable function (PUF) encryption or other authentication method.

Certain embodiments can also provide a method to prevent a secure storage device that is configured to operate in one computer system, netbook, or laptop, from operating in another identical or similar device. This may help to prevent stolen storage devices from operating in non-authorized environments, even if the key fob and other authentication data is possessed or known. One method to implement this feature can use a small crypto device inserted into the computer system, for example in series with the power connector.

Certain embodiments may provide an ability to pair multiple laptops to a single encryption key fob, an encryption key and/or any other authentication factor. Moreover, certain embodiments may provide the ability to support a number of other authentication methods, devices, or bio-metric authentication techniques by connecting them to the USB interface on the back side of the key fob. For example, a radio frequency (RF) receiver or global positioning system (GPS) device could be connected to the key fob for use as a further method for authentication by detecting a specific RF signal or physical location.

Certain embodiments can be used to help prevent unauthorized access of computer data through the use of encryption and multi-factor authentication by providing a secure method to implement the security features. For example, certain embodiments can load the encryption key, authentication data, and/or password through a separate interface, with no operating system involvement and no shared data paths.

One configuration of certain embodiments is the key fob. The key fob can self-generate or be loaded with an encryption key. The key fob can also hold authentication data or one of a pair of split keys.

The key fob can also have other features. For example, one end of the key fob can have an interface that plugs into the bezel of the secure storage device and the other end can have a second interface. The second interface on the key fob can be a standard USB interface. The USB interface can allow a user to use a standard USB keyboard to enter passwords. Additionally, the USB port on the key fob can provide a way to support other types of security, data holding, biometric, or authentication devices by attaching them to the key fob.

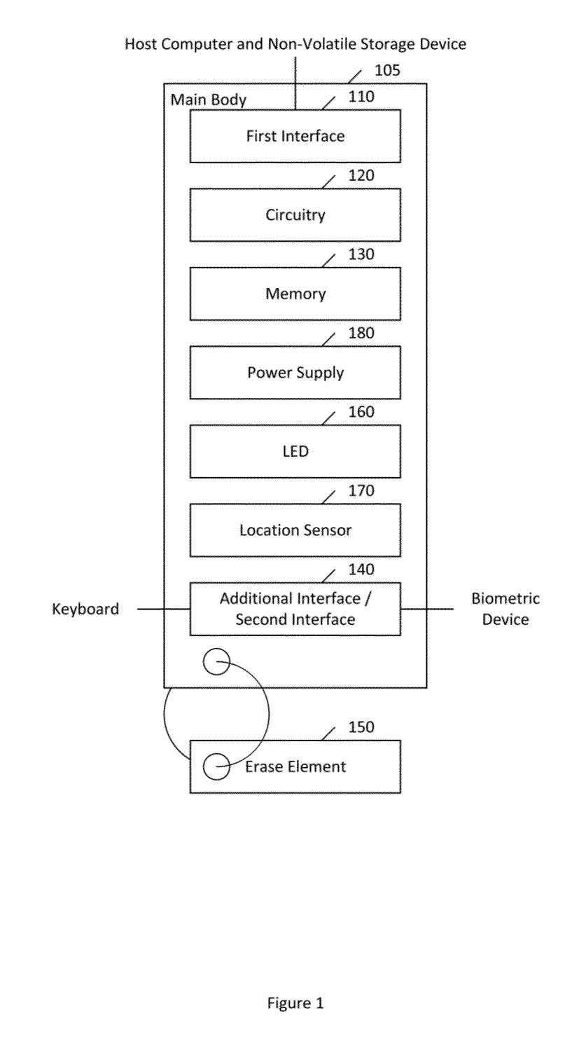

FIG. 1 illustrates an apparatus according to certain embodiments. The apparatus 105 can be, for example, a crypto key device. As shown in FIG. 1, the apparatus 105 can include a first interface 110 configured to connect to a non-volatile storage device, which in turn can be connected to a host computer. The first interface 110 can be configured to connect directly to the non-volatile storage device.

The non-volatile storage device may be, for example a solid state drive or other hard disk drive, such as a traditional platter-based hard disk drive. The drive can be a removable drive. Alternatively, the non-volatile storage device can be non-removable, such as if a ball grid array (BGA) is employed for connection into a computer. Other storage devices are also permitted.

The apparatus 105 can also include circuitry 120 configured to supply an encryption key over the first interface to decrypt data on the non-volatile storage device. The circuitry 120 may be a processor, controller, or other active circuitry. Alternatively, the circuitry 120 may be passive circuitry.

The circuitry 120 of the apparatus 105 can further be configured to receive a password from an additional interface and at least one of supply the encryption key based on the received password or supply the password to the non-volatile storage device.

The apparatus 105 can also include a memory 130 configured to store a key or an encrypted key, wherein the key or the encrypted key can be supplied as the encryption key. The memory 130 can be a volatile memory or a non-volatile memory. The memory 130 can, for example, include a random access memory (RAM), such as a micro-secure digital (micro-SD) RAM.

The apparatus 105 can further include an additional interface 140 configured to connect to at least one of a keyboard or a biometric device. The biometric device may be, for example, an iris scanner, a voice recognition circuit, or a fingerprint reader. Other biometric devices are also permitted.

The apparatus 105 can include an erase element 150, wherein the erase element 150 is configured to trigger the non-volatile storage device to erase itself when the erase element is inserted directly into the non-volatile storage device. In certain embodiments, the erase element 150 can be connected to a main body of the apparatus 105 via a ring, such as a key ring. The ring can pass through a hole in the erase element 150 and in the main body of the apparatus 105. The hole in the main body can be at the same end as the additional interface 140 for the keyboard or biometric device.

The apparatus 105 can also include a second interface, which may be the same as additional interface 140 comprising a serial port. The serial port may be a port configured to operate as a universal serial bus (USB) port.

The apparatus 105 may further include at least one light emitting diode (LED) or a small display 160 configured to indicate a status of the apparatus 105. The status of the apparatus 105 can include a status of at least one of a password, a key, or entered data.

The apparatus 105 can additionally include a location sensor 170, such as a radio frequency receiver or a global positioning system device. The apparatus 105 can be configured to further authenticate based on detecting a specific radio frequency signal or physical location.

The apparatus 105 can also include a power supply 180. The power supply 180 can be a removable battery. Removal of the battery by the user may erase a key stored in the apparatus 105 by powering off all or portions of the apparatus 105 when removed. For example, a user carrying around the key fob may desire to delete/purge the key or encrypted key from the key fob. To do this, a small battery in the key fob can maintain the key value by maintaining power to a volatile memory. The battery may or may not be replaceable. A small round shaped protrusion, when unscrewed, can cause the key value to clear by breaking the battery connection to an internal memory. If the battery is replaceable, a screw head type protrusion can allow battery replacement.

Other ways of erasing the key are also possible. For example, the key can be magnetically stored and can be erased by placing a strong magnet or electromagnet close to apparatus 105. Certain magnetic storage devices are permanently destroyed by the application of strong magnetic fields so this method can also provide to a way to permanently destroy apparatus 105.

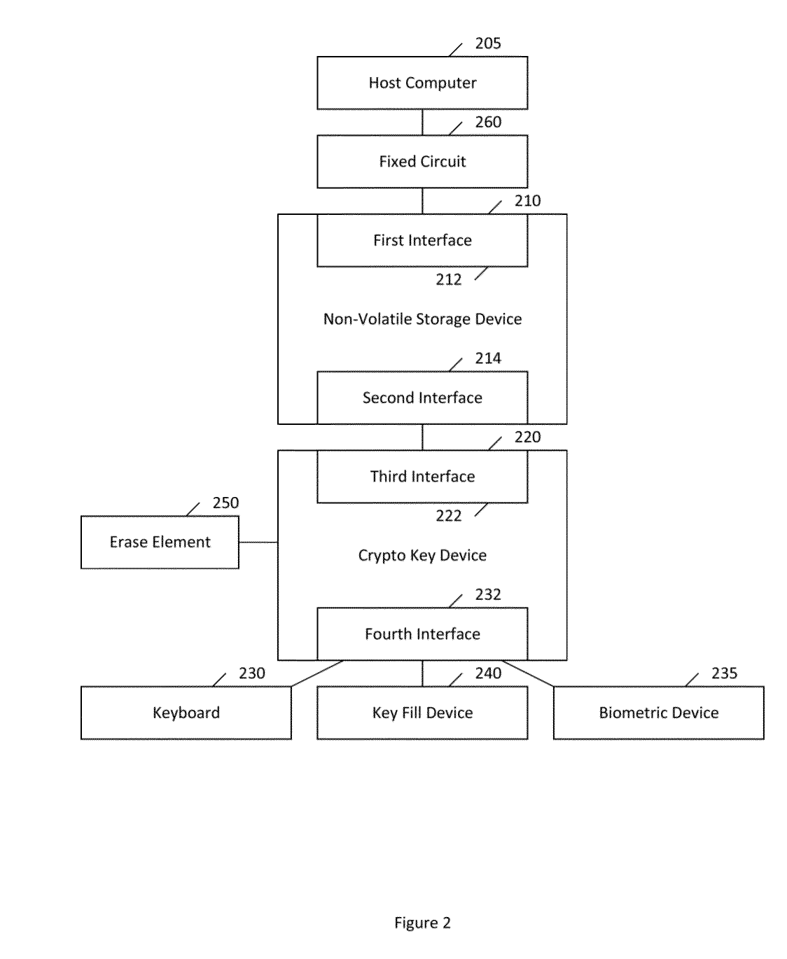

FIG. 2 illustrates a system according to certain embodiments. As shown in FIG. 2, a system can include a non-volatile storage device 210 comprising a first interface 212 to a host computer 205 and a second interface 214 away from the host computer 205.

The non-volatile storage device 210 can be configured to use a laptop bay of a removable compact disk or digital versatile disk drive. For example, the non-volatile storage device 210 can be swapped into the host computer in place of a DVD/CD-ROM drive or any removable drive.

The non-volatile storage device 210 can be configured to perform encryption and multi-factor authentication. The multi-factor authentication can involve the various elements of the system. The non-volatile storage device 210 can be configured to perform authentication without data interaction with the host computer 205. Moreover, the non-volatile storage device 210 can be a solid state drive or any of the other options mentioned above.

The system can also include a crypto key device 220 comprising a third interface 222 configured to connect to the second interface 214 of the non-volatile storage device 210 and circuitry configured to supply an encryption key over the third interface 222 to decrypt data on the non-volatile storage device 210. The details of the crypto key device 220 can be seen, for example, in FIG. 1.

As shown in FIG. 2, the third interface 222 can be configured to connect directly to the second interface 214. In other words, the two interfaces can physically interconnect, such as with one interface providing a male connector and the other interface providing a female connector. The second interface 214, the third interface 222, or both can be a serial port. For example, these ports can be USB ports.

The system can also include at least one of a keyboard 230 or a biometric device 235. One or both of the keyboard 230 and the biometric device 235 can be configured to connect to the crypto key device 220 at a fourth interface 232.

The system can further include a key fill device 240. The key fill device 240 can be configured to connect to the crypto key device 220 at the fourth interface 232 and/or the third interface 222 and/or connect to the non-volatile storage device 210 at the second interface 214.

Thus, for example, a connector on the hard drive that connects to a key fob can also allow a connection to a standard key fill device. The key fill device can load a key encryption key (KEK) into the drive. The key fob can also connect to the key fill device to get the encrypted key. After the drive gets the KEK and after the key fob gets the encrypted key, the key fob can plug into the drive.

The system can additionally include an erase element 250. The erase element 250 can be configured to trigger the non-volatile storage device 210 to erase itself when the erase element 250 is inserted directly into the non-volatile storage device 210.

The system can also include a fixed circuit 260 provided electrically between the non-volatile storage device 210 and the host computer 205. The fixed circuit 260 can be configured to be detected by the non-volatile storage device 210.

Thus, a mechanism, such as a small printed circuit board (PCB) can be mechanically attached to a host laptop. The mechanism assembly can insert into a CD-ROM bay between a hard drive and the laptop, for example in series with the laptop-to-drive signal/power connection. Once inserted, the mechanism may not easily be removed. The mechanism can be small and not easily identified because it can be obscured by the depth of insertion in the CD-ROM bay. The mechanism can contain circuitry that the drive can detect/evaluate and identify. Thus, a user can make sure the drive will only work in a specific laptop. The removable drive will refuse to operate if it does not detect the circuit.

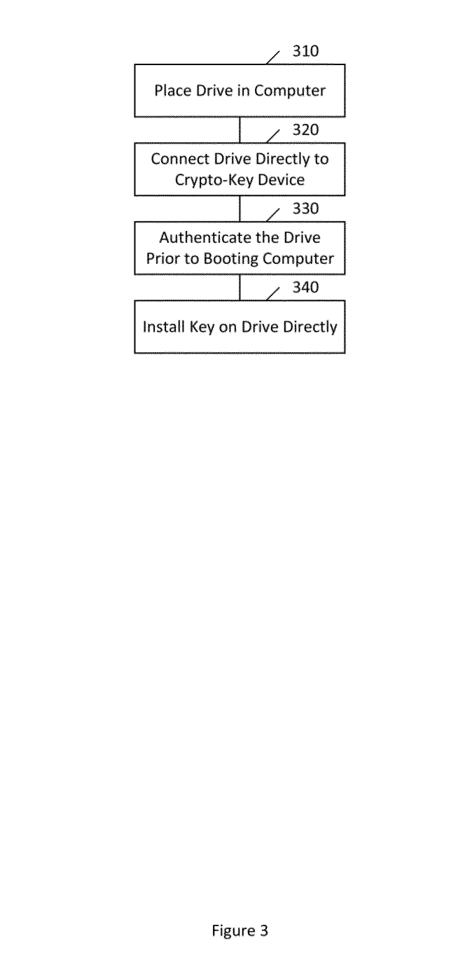

FIG. 3 illustrates a method according to certain embodiments. As shown in FIG. 3, a method may include, at 310, placing a drive in a computer. The drive may be a solid-state drive, or any of the other drives mentioned herein.

The method can also include, at 320, connecting the drive directly to a crypto-key device. This can be performed by connecting the drive to a crypto-key device using a data signal path that does not pass through the host computer.

The method can further include, at 330, authenticating to the drive prior to booting the computer. For example, after the computer receives power, but before the computer boots, the drive can verify that the key fob is authentic, then receive a key from or via the crypto-key device, authenticate the key, and permit access to the drive based on the authentication.

When a computer first turns on, the processor in the computer can get its first instructions from the basic input/output system (BIOS) read only memory (ROM) chip. For a short time, the BIOS can actually be running the laptop/computer. The goal of the BIOS code may be to setup the system chips that reside on the laptop/computer motherboard and then to load the operating system (OS) and give control to the OS. Certain embodiments provide a system for authentication that isolates the OS from the authentication process. At some point, the BIOS can try to access the boot drive, which may be a secure solid-state drive (SSD). When the BIOS tries to access the SSD, the SSD can respond that its internal security system is locked and that it needs the correct password sent to it before it will give up any data.

The BIOS is not typically established to “know” what the password should be, so it may do the only thing it can do. It may display a “Password” message to the user on the laptop/computer screen.

While this password screen is displayed by the BIOS, the OS boot process may be indefinitely stalled. Since the BIOS is waiting for the user, authentication can be conducted entirely by the SSD. The OS is not booted yet. Thus, the BIOS can wait for a password. The SSD can be waiting for the user to insert a crypto-key device or keyboard or both, and for the authentication process to complete correctly. If the user tries to bypass the authentication process by entering any sort of password on the laptop/computer keyboard, the SSD can tell the BIOS it is an incorrect password and the BIOS will again display the “password” screen.

After the drive finishes authenticating with the crypto-key device and/or keyboard or possibly other devices, the drive can then accept a password from the user. This password can be entered by the user from the laptop or computer keyboard. Since secure authentication has already completed at this point, the SSD could accept anything that the user enters, as one option.

The drive can then tell the BIOS that the drive is unlocked. At that point the BIOS may be able to get to any data on the drive, which may allow it to boot to the OS.

The method can also include other steps disclosed above. For example, at 340, the method can include installing one key of a key pair on the drive directly, namely without relying on data signals in the host computer.

Various modifications to certain embodiments are possible. For example, the keyboard can be a standard USB keyboard. Alternatively, the keyboard can be a wireless keyboard, and the crypto-key device can be configured to communicate wirelessly with the keyboard.

As mentioned above, one or more LEDs can be installed on the crypto-key device. Alternatively, a small display, such as an organic electroluminescent display (OELD) or a liquid crystal display (LCD) can be installed on the crypto-key device. The display and/or LEDs can provide feedback to a user trying to type a password. For example, a count of characters typed or some way to allow backspace to work correctly can be indicated.

Certain embodiments may have various benefits or advantages. For example, certain embodiments may provide the ability to keep the OS fully isolated from the authentication process. In certain embodiments, the drive may do all of the authentication, and then let the OS start to boot from the same drive after the authentication completes.

Moreover, certain embodiments may permit using a CD/DVD slot as the primary secure boot device for the laptop. This permits an otherwise normal laptop to be secured without unscrewing the laptop's case.

In certain embodiments, the connector on the drive itself, to which the crypto-key connector is connected, may not be a USB connector. However, the crypto-key connector itself can have a USB connector, which can be used for a USB keyboard.

According to certain embodiments, using a reset stick in the drive can either trigger an encryption key clear operation or a full clear operation. Furthermore, certain embodiments can use a single small integrated circuit device, coupled to a short PCB that is inserted into the laptop into the same slot as the drive. This board can friction-fit into position making a series connection with the laptop power connector and the power connector on the drive. The board can be inserted once and then may be resident forever. The drive can plug into the CD-ROM/DVD slot and the power connector of the drive can engage into the power connector on the crypto PCB, in series. If an unauthorized user somehow removed the small board, then tried to plug the SSD directly into the laptop, authentication would fail, because the crypto board is not there, and the laptop would not boot.

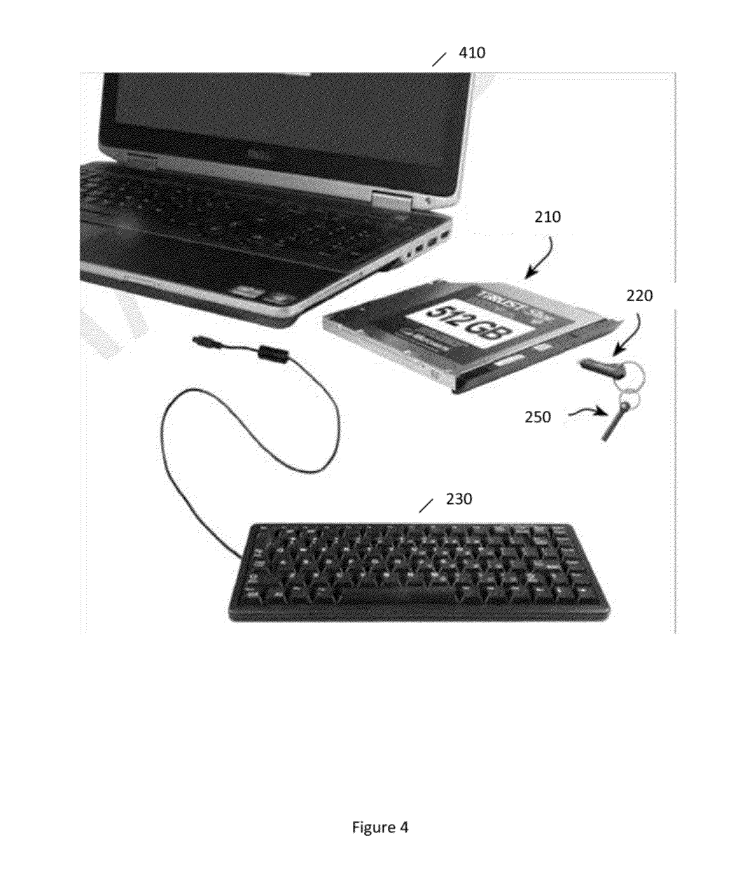

FIG. 4 illustrates a particular system according to certain embodiments. As shown in FIG. 4, a host computer 410 can have a slot for a removable drive on the side of its chassis. A drive 210, here illustrated by a 512 GB capacity drive, can be inserted into the slot. The drive can have an external port into which a crypto-key device 220 can be inserted. The crypto-key device 220 can be provided on a key ring set with an erase element 250. Additionally, the crypto-key device 220 can be configured to permit keyboard 230 to be used to enter a password through or to the crypto-key device 220.

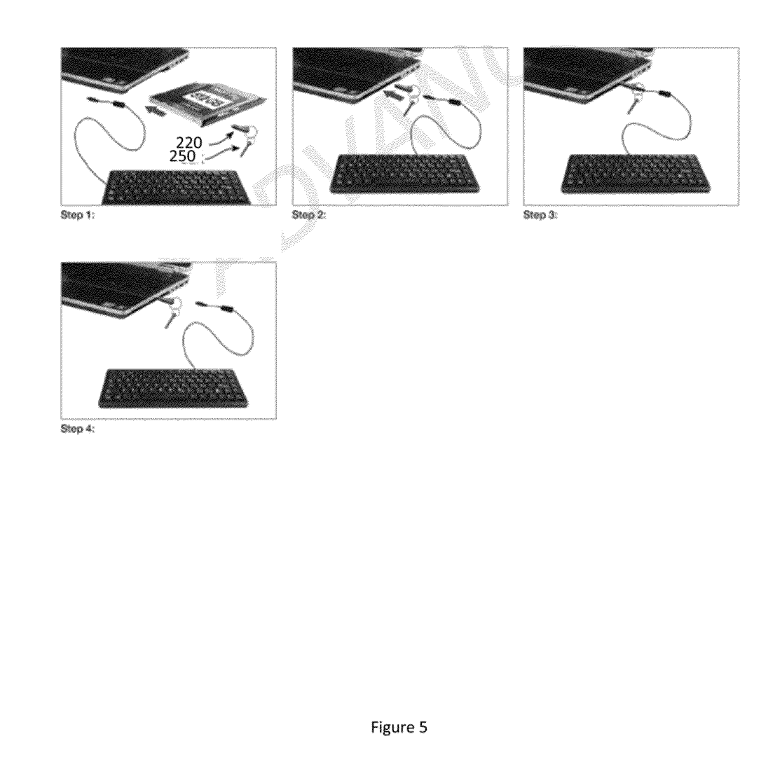

FIG. 5 illustrates a particular method according to certain embodiments. As shown in FIG. 5, at step 1 the drive can be inserted into the laptop. Then, at step 2 the crypto-key device 220 can be inserted into the drive. Subsequently, at step 3, the keyboard can be connected to the crypto-key device 220. At this time, a password, such as a fourteen character password, can be entered. After authentication, at step 4, the keyboard can be removed but the crypto-key device 220 can remain in place.

These steps can be performed in a different order. For example, the keyboard can already been connected when the crypto-key device 220 is inserted into the drive. Alternatively, the keyboard can be omitted, and the crypto-key device 220 can be pre-programmed with the password.

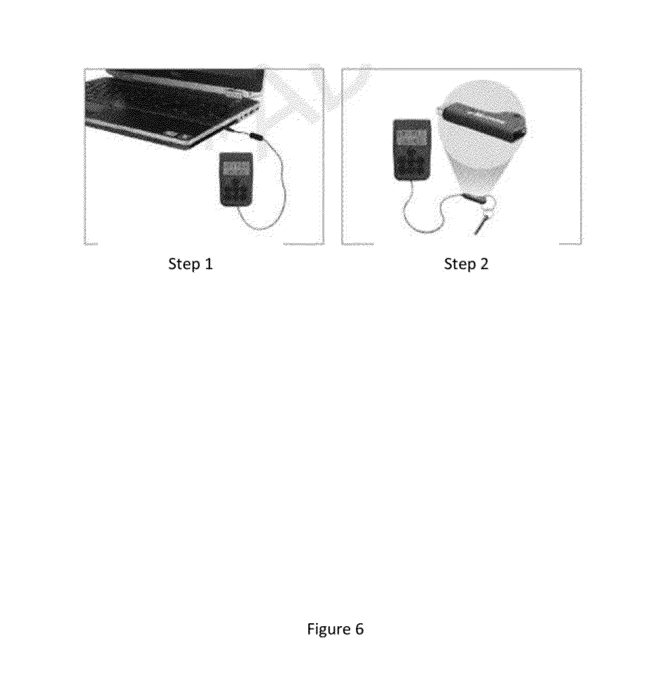

FIG. 6 illustrates a further method according to certain embodiments. As shown in FIG. 6, at step 1, a key-fill device can be connected to the drive and a key can be provided to the drive. Then, at step 2, the key fill device can be connected to the crypto-key device and a corresponding key can be provided to the crypto-key device.

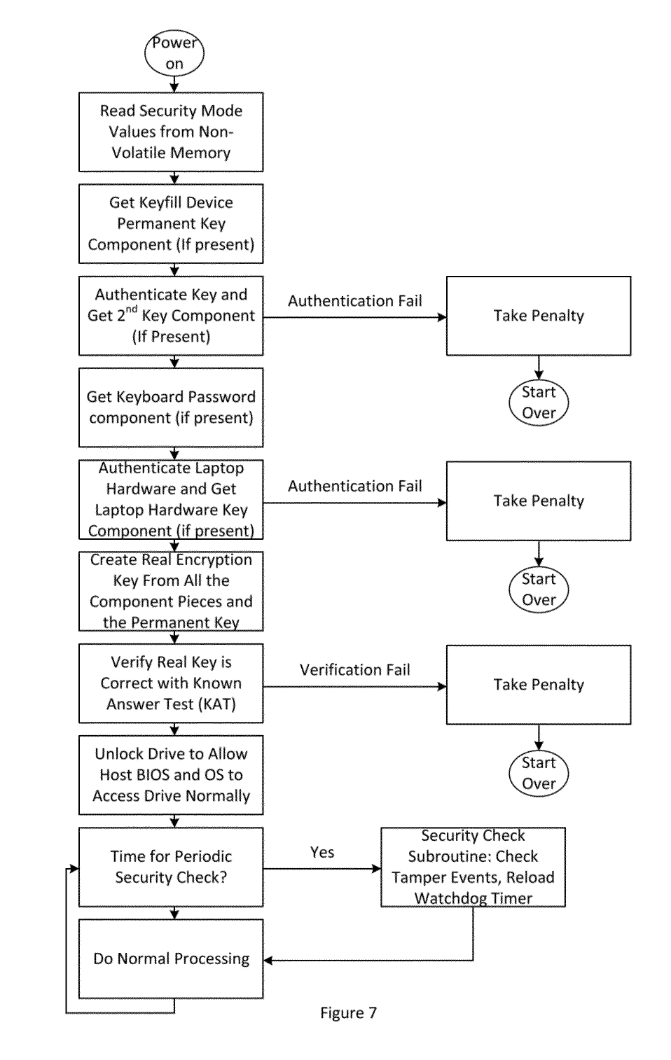

FIG. 7 illustrates an additional method according to certain embodiments. For example, FIG. 7 provides a secure storage drive-centric security flow diagram. As shown in FIG. 7, a process can begin at power on. Then, security mode values can be read from non-volatile memory. After that, the system can get a key fill device permanent key component, if present. The system can authenticate a key from a crypto-key device and get a second key component, namely a key component associated with the crypto-key device, if present. If authentication fails there can be a penalty provided, and then the process can start over.

If authentication succeeds, the system can get a keyboard password component, if present. The keyboard referenced here can be an external keyboard rather than the keyboard of the host computer. The system can then authenticate laptop hardware and get a laptop key component, if present. Again, if authentication fails there can be a penalty, and then the process can start over.

If authentication succeeds, the system can create a real encryption key from all the component pieces and a permanent key located in the drive itself. The system can then verify that the real key is correct, with a known answer test (KAT). If this test is negative, then a penalty can be taken and the process can start over, as above.

If the test is passed, the system can unlock the drive to allow the host BIOS and OS to access the drive normally.

The system can impose a periodic security check. Thus, when it is time for such a check, the system can implement a security check subroutine in which there is a check for any tamper events. The system can also then reload a watchdog timer. If the watchdog timer gets down to zero, then the hardware can clear the encryption key.

This security model may isolate the BIOS and the host operating system from the password and encryption key. Thus, this model may ensure that attacks on the BIOS and OS, even using the Internet, will not be able to get the password or encryption key.

One having ordinary skill in the art will readily understand that the invention, as discussed above, may be practiced with steps in a different order, and/or with hardware elements in configurations which are different than those which are disclosed. Therefore, although the invention has been described based upon certain disclosed embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An apparatus, comprising:
a first interface configured to connect to a provided non-volatile storage device; and
circuitry configured to supply an encryption key over the first interface to decrypt data on the provided non-volatile storage device,
wherein the first interface is configured to connect directly to the provided non-volatile storage device.

2. The apparatus of claim 1, further comprising:
a memory configured to store a key or an encrypted key, wherein the key or the encrypted key is supplied as the encryption key.

3. The apparatus of claim 1, further comprising:
an additional interface configured to connect to at least one of a provided keyboard or a provided biometric device.

4. The apparatus of claim 1, wherein the circuitry of the apparatus is further configured to receive a password from an additional interface and at least one of supply the encryption key based on the received password or supply the password to the provided non-volatile storage device.

5. The apparatus of claim 1, further comprising:
an erase element, wherein the erase element is configured to trigger the provided non-volatile storage device to erase itself when the erase element is inserted directly into the provided non-volatile storage device.

6. The apparatus of claim 1, further comprising:
a second interface comprising a serial port.

7. The apparatus of claim 1, further comprising:
at least one light emitting diode or a display configured to indicate a status of the apparatus.

8. The apparatus of claim 7, wherein the status of the apparatus comprises a status of at least one of a password, a key and entered data.

9. The apparatus of claim 1, further comprising:
at least one of a radio frequency receiver and a global positioning system device, wherein the apparatus is configured to further authenticate based on detecting a specific radio frequency signal or physical location.

10. The apparatus of claim 1, further comprising:
a removable battery configured to erase a key stored in the apparatus by powering off the apparatus when removed.

11. A system, comprising:
a non-volatile storage device comprising a first interface to a provided host computer and a second interface away from the provided host computer;
a crypto key device comprising a third interface configured to connect to the second interface of the non-volatile storage device and circuitry configured to supply an encryption key over the third interface to decrypt data on the non-volatile storage device,
wherein the third interface is configured to connect directly to the second interface.

12. The system of claim 11, wherein the circuitry of the crypto key device is further configured to receive a password from an additional interface and supply the encryption key based on the received password.

13. The system of claim 11, further comprising:
at least one of a keyboard or a biometric device, wherein the at least one of the keyboard or the biometric device is configured to connect to the crypto key device at a fourth interface.

14. The system of claim 11, further comprising:
a key fill device, wherein the key fill device is configured to at least one of connect to the crypto key device at a fourth interface or connect to the non-volatile storage device at the second interface.

15. The system of claim 11, further comprising:
an erase element, wherein the erase element is configured to trigger the non-volatile storage device to erase itself and/or erase encryption keys when the erase element is inserted directly into the non-volatile storage device.

16. The systems of claim 11, wherein the non-volatile storage device is configured to use a laptop bay of a removable compact disk or digital versatile disk drive.

17. The system of claim 11, wherein the non-volatile storage device is configured to perform encryption and multi-factor authentication.

18. The system of claim 11, wherein the non-volatile storage device is configured to perform authentication without intervention or interaction of the provided host computer.

19. The system of claim 11, wherein the non-volatile storage device comprises a solid state drive.

20. The system of claim 11, wherein at least one of the second interface or the third interface comprises a serial port.

21. The system of claim 11, wherein the crypto key device further comprises at least one light emitting diode or display configured to indicate a status of the crypto key device.

22. The system of claim 21, wherein the status of the crypto key device comprises a status of at least one of a password, a key, or entered data.

23. The system of claim 11, wherein the crypto key device further comprises a radio frequency receiver or a global positioning system device, wherein the crypto key device is configured to further authenticate based on detecting a specific radio frequency signal or physical location.

24. The system of claim 11, further comprising:
a fixed circuit provided electrically between the non-volatile storage device and the host computer, wherein the fixed circuit is configured to be detectable by the non-volatile storage device.

25. A method, comprising:
powering on a secure storage device using a host computer; and
authenticating access to the secure storage device using at least one key,
wherein the authenticating bypasses an operating system and a basic input/output system of the host computer.

26. The method of claim 25, further comprising:
providing at least one key to the secure storage device from a crypto-key device connected directly to the secure storage device.

27. The method of claim 25, further comprising:
destroying or permanently disabling the secure storage device by inserting a magnetic erase stick into a port configured to receive the magnetic erase stick, wherein the port is configured to be in close proximity to magnetic random access memory of the secure storage device.
